(19) United States
(12) Patent Application Publication
(10) Pub. No.: US 2026/0200127 A1
(43) Pub. Date: Jul. 16, 2026

(54) MOULDABLE COMPOSITION

(71) Applicant: DELTA OF SWEDEN AB, Halmstad (SE)

(72) Inventors: Krister THURESSON, Halmstad (SE); Josefine HENRIKSSON, Halmstad (SE); Jonas MODELL, Halmstad (SE)

(21) Appl. No.: 19/131,324

(22) PCT Filed: Nov. 21, 2023
(86) PCT No.: PCT/EP2023/082563

§ 371 Date: May 20, 2025

(30) Foreign Application Priority Data
Nov. 21, 2023 (GB) 2217391.8

(51) Int. Cl. B27N 3/00; B27N 3/02; B27N 5/00; C08F 218/08; C08K 5/05; C08K 5/103

(52) U.S. Cl. CPC B27N 3/002; B27N 3/02; B27N 5/00; C08F 218/08; C08K 5/05; C08K 5/103; C08K 2201/019

(57) ABSTRACT

The present invention relates to a mouldable material containing; a) at least one binder; and b) at least one particulate filler material. The filler material includes a natural, non-porous filler material such as cork or coconut fibre. The invention additionally provides product such as a modelling compound, an artistic material, a child's play material, a filler material, a construction material, a packaging material, an insulating material and/or a fire-retardant material comprising, made from the mouldable material. A method for producing the mouldable material is also provided.

### FIELD OF THE INVENTION

The present invention relates to mouldable compositions comprising a binder and at least one filler, where the filler comprises a natural product. In particular, the invention relates to such materials where the filler is a non-food product such as a lignin-containing product and especially a suberin-containing product.

### BACKGROUND TO THE INVENTION

Mouldable compositions are useful for a wide variety of uses. Children's play compositions such as doughs and moulding clays are a very common use but many others exist, including artistic pursuits such as sculpture and industrial uses such as in construction, sound or thermal insulation and packaging.

Many mouldable compositions are formed from at least one binder material and at least one filler. The filler serves to provide bulk to the material and affects properties such as the density, compressibility, thermal and acoustic properties of the composition. The binder serves primarily to hold the composition together and may contribute to properties such as strength and rigidity. Mouldable materials comprising a filler and a binder may be mouldable at room temperature or may require heating to become mouldable and then set again upon cooling. Similarly, mouldable materials may be permanently mouldable or may become “set” by an action such as drying, heating or chemical reaction.

A wide variety of particulate materials have been used or proposed as all or a part of the filler component in mouldable materials. These include inorganic fillers such as sand, chalk, mica, glass etc, synthetic polymers such as resin beads, expanded polymeric materials, polymeric microbubbles etc and natural materials such as edible flours including wheat flour or rice flour.

Natural filler materials provide several potential advantages over inorganic or synthetic materials. They are generally easy and potentially inexpensive to source since they are often part of an existing natural-product industry, they are typically bio-compatible with low biological impact and/or widely established safety profiles and/or they are comparatively environmentally friendly, both in sourcing and in disposal. Most natural-product based fillers will be carbon based and having been generated in the recent past will serve to sequester carbon from the atmosphere.

When such products reach the end of their useful lives, the filler material may be readily disposed of since, as a natural product, natural degradation mechanisms exist and allow for environmentally compatible disposal. Furthermore, any carbon released into the atmosphere in such a process is no greater than the amount of carbon captured in the generation of the material, resulting in no net release of carbon from the filler material.

Most commonly used natural filler materials are food product materials. That is to say they are, or are derived from, edible materials such as starch. Edible flours such as wheat or rice flours are typical examples. These types of flours form the basis of many of the simplest moulding compositions, such as simple flour and water doughs. However, such fillers have several disadvantages. Firstly, the fillers are generally permeable to the binder material (such as water), which means that the filler must become saturated with the binder before a surface-binding effect is achieved. With other binder materials, the permeability of the filler may not result in the immediate need to “saturate” the filler but may cause the binder to gradually permeate into the filler so that the composition gradually becomes dry and less cohesive, even where the binder itself is not drying but simply being absorbed into the filler particles. Although convenient, it is also preferable to limit the use of edible materials which could be utilised in human or animal food for the production of non-food items such as modelling compositions.

The present inventors have looked for alternative naturally derived filler materials suitable for use in moulding compositions, especially those which are not formed of or from edible materials such as starches. Unfortunately, many common, particulate natural materials perform poorly when used as filler materials. In particular, many natural particulate materials such as flours, wood-chips, sawdust, paper-dust etc. tend to absorb the binder materials, either immediately or gradually over time. As a result, the mouldable material may require large quantities of binder, or may gradually lose binder on the surface of the filler, due to absorption.

This may result in the material becoming less cohesive over time and losing its mouldable properties, either in use or during storage.

In view of the above, it would be a considerable advantage to provide a mouldable material comprising a natural or naturally-derived filler material which does not absorb binder materials beyond the surface layer and/or which can remain cohesive and mouldable when in use and/or storage.

The present inventors have surprisingly established that mouldable materials formed with particles of closed-cell natural materials absorb binder only on their surfaces and thus require less binder and/or do not lose cohesion due to binder absorption.

### SUMMARY OF THE INVENTION

In a first aspect, the present invention provides a mouldable material comprising
a) at least one binder and;
b) at least one particulate filler material.

In particular, wherein the filler material is a natural filler material, particularly a non-porous filler material such as a closed-cell filler material.

A highly suitable filler material for use in all aspects of the present invention is cork.

The mouldable materials of the present invention are useful in various technologies. In particular, the present disclosure provides, in various aspects, a modelling compound, an artistic material, a child's play material, a filler material, a construction material, a packaging material, an insulating material and/or a fire-retardant material comprising, consisting essentially of or consisting of the mouldable composition described herein in any aspect or embodiment.

The mouldable materials of the present invention may be generated by combining a suitable binder material (as described in any compatible embodiment herein) with the particulate filler material (as described in any compatible embodiment herein). In a corresponding aspect, the present disclosure thus provides a method for forming a mouldable material as described herein in any aspect or embodiment, the method comprising combining a binder material with a particulate filler material.

### BRIEF DESCRIPTION OF THE FIGURES

FIG. 1 Shows a scanning electron micrograph of the surface of a cork sample, showing the closed-cell nature of the material.*

FIG. 2 Shows a Scanning (A) and Transmission (B) electron micrograph of a sample of oak wood.**

FIG. 3 shows a scanning electron micrograph of the surface of a sample of untreated corn cobs.†

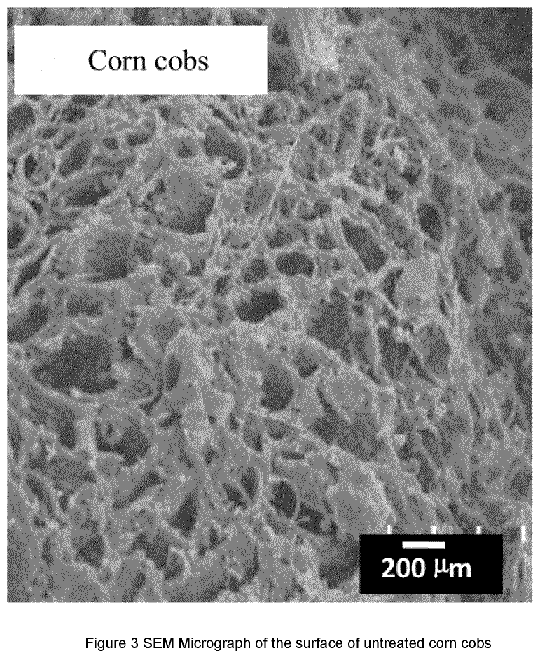

*Image by Nicola Angeli/MUSEThis file was uploaded by MUSE-Science Museum of Trento in cooperation with Wikimedia Italia.—MUSE, CC BY-SA 3.0, https://commons.wikimedia.org/w/index.php?curid=48378572
** Image by McKDandy at English Wikipedia-CC BY 2.5, https://en.wikipedia.org/wiki/Vessel_element#/media/File:Hardwood_Pores.jpg
† Cropped from Image by Linna Suo, Xiangyang Sun, Weijie Jiang at Public Library of Science-CC BY 4.0, https://doi.org/10.1371/journal.pone.0064550.g001

### DETAILED DESCRIPTION OF THE INVENTION

The mouldable materials of the present disclosure comprise two key components; a binder component and a particulate non-porous (especially closed-cell) filler component. The filler material is particularly a natural filler material.

The particulate non-porous (especially closed-cell) filler component is of key importance in the present invention because many of the key attributes of the products of the present disclosure may be attributed to the non-porous (especially closed-cell) filler material and to the interaction of the filler material with the binder material. The non-porosity and/or closed-cell nature of the filler material is a key feature of the invention since this allows more efficient filler to binder ratios and improves the longer-term properties of the materials. In a preferred embodiment, the filler material will be free or substantially free of porous materials.

In one key embodiment, the non-porous (e.g. closed-cell) filler material is a natural material. By “natural material”, as used herein, it is indicated that the filler material can be sourced from at least one living (or previously living) entity. For example, the natural material may be sourced from an organism that was living at some time during the preceding 20 years. In particular, preferred natural materials will typically be sourced (or be capable of being sourced) from living (or previously living) organisms such as plants, animals, fungi, protists and/or prokaryotic microbes. Highly suitable organisms include plants and fungi, particularly plants (e.g. trees). It is preferable that natural products are derived from their generating organisms by physical, chemical and/or biological methods. Physical methods such as mechanical separation, heating, grinding, cutting and similar methods are highly effective and generate minimal waste. Biological methods, such as the use of microorganisms and/or enzymes are appropriate for some natural products and typically generate waste with a relatively low environmental impact. Chemical methods may be used but are generally less preferable since the waste generated may have a higher environmental impact. Natural products which can be separated by physical and/or biological methods are preferred. Examples include cork and coconut fibre.

In a preferred embodiment, the non-porous (e.g. closed cell) filler material is not an inorganic material (e.g. not a mineral). In a preferred embodiment, the non-porous (e.g. closed cell) filler is free or substantially free of metals and/or metal ions (e.g. alkali metal ions, such as sodium ions). In one embodiment, the filler material comprises less than 20% (e.g. 0 to 20%) by weight or less than 20% (e.g. 0 to 20%) by volume inorganic material (e.g. mineral material). Generally this will be less than 10%, such as less than 5% by weight or less than 10%, such as less than 5% by volume.

In one embodiment, the non-porous natural filler material may be compressible. By compressible is indicated that the filler material can be compressed to 90% of its length in its longest dimension and return to at least 95% (e.g. 95 to 100%) of its original length within 24 hours. In one embodiment, a compressible natural material is such that a 10 mm cube of the natural material may be compressed to 90% of its length in one dimension with a force of no more than 1000N (e.g. 25 to 1000N), preferably no more than 500N or no more than 300N.

A valuable property of a compressible natural material as the filler material in the various embodiments of the present invention is that compression of the material can result in a temporary redistribution of the binder material over the filler surface. This results in a material with the property that it will be cohesive when compressed but not sticky or tacky to the touch. In one embodiment, therefore, the filler material comprises or consists of at least one compressible natural material and the composition of any aspect or embodiment of the invention is cohesive when compressed by manual pressure but not sticky or tacky to the touch.

When materials of this type are compressed into small “bricks” by hand, by extrusion or in a small mould (bricks e.g. 1-10 cm in each dimension), the resulting bricks show cohesion when pressed together but do not stick to hands or surfaces.

In one embodiment, small bricks formed from the material of the invention may be adhered together by pressing together but are not sticky to hands and/or work surfaces. In a corresponding embodiment, small bricks formed from the material of the invention may be adhered together by pressing together by manual force but not adhered together solely by the force of stacking one upon another.

Among plant-derived natural products, products derived from trees are highly appropriate since trees provide many environmental advantages in their sequestration of carbon from the atmosphere, stabilisation of soils and resistance to “desertification” of the land. Materials which can be harvested without destruction of the trees offer a further advantage in not disrupting these properties. Cork and coconut fibres are examples of materials which can be harvested from trees without killing the tree, cork being the outer bark layer, which regenerates, and coconut fibre being formed around the fruit/seed of the plant.

A key attribute of the non-porous/closed-cell filler materials suitable for use in the present invention is that they should have limited absorption of the binder material(s). This is believed to be related to the non-porous/closed-cell nature of the filler material. Without being bound by theory, it is believed that this reduces the weight of binder required to coat the filler material and also reduces or prevents the “drying” of the mouldable composition by absorption of binder material into the bulk of the filler material. It is thus highly desirable that the particulate filler material of the present invention be a “closed cell” filler material. “Closed cell” filler materials as used herein indicate materials which are non-porous or substantially non-porous.

The closed-cell filler material referred to herein in all aspects and embodiments may be a non-porous natural material. In particular, non-porous materials should not contain surface pores larger than 2 μm (e.g. 2 to 200 μm) in diameter which are deeper than 100 μm (e.g. 100 μm to 1 cm), and will preferably not have pores larger than 1 μm in diameter to a depth of more than 50 μm. Pores are considered absent on the surface of a material if less than 10% or 5% (e.g. 0 to 5% or 0.00001 to 5%), preferably less than 1% of the surface area of the material is formed of pores of the sizes described. In one embodiment, this may be less than 0.1% by surface area.

Closed-cell filler materials, by virtue of being a non-porous material, should not contain surface pores larger than 2 μm (e.g. 2 to 200 μm) in diameter which are deeper than 100 μm (e.g. 100 μm to 1 cm), and will preferably not have pores larger than 1 μm in diameter to a depth of more than 50 μm. Pores are considered absent on the surface of the closed-cell filler material if less than 10% or 5% (e.g. 0 to 5% or 0.00001 to 5%), preferably less than 1% of the surface area of the material is formed of pores of the sizes described. In one embodiment, this may be less than 0.1% by surface area. “Closed cell” materials, as used herein are generally materials comprising gas-containing cells which do not permit passage of liquid or similar, non-gaseous fluid (especially binder) from one cell to neighbouring cells. Some materials, such as cork, permit permeation of a small quantity of gas between cells but this is irrelevant to the present invention since it does not affect the absorption of binder (typically a fairly viscous liquid). In one embodiment the non porous material is a closed cell material formed of gas-containing cells which do not allow passage of liquid (especially binder, such as any of those described herein) from one cell to the next.

In one embodiment, the natural material is a multi-cell material. By a multi-cell material is indicated a material comprised of sealed gas-containing cells where multiple cells adjoin with a common wall between. In one embodiment, a 10 mm cube of multi-cell natural material will comprise at least 10,000 cells (e.g. 10,000 to 100,000,000), preferably at least 50,000 or at least 500,000 gas-filled cells. Generally the closed-cell material described herein will be a multi-cell material.

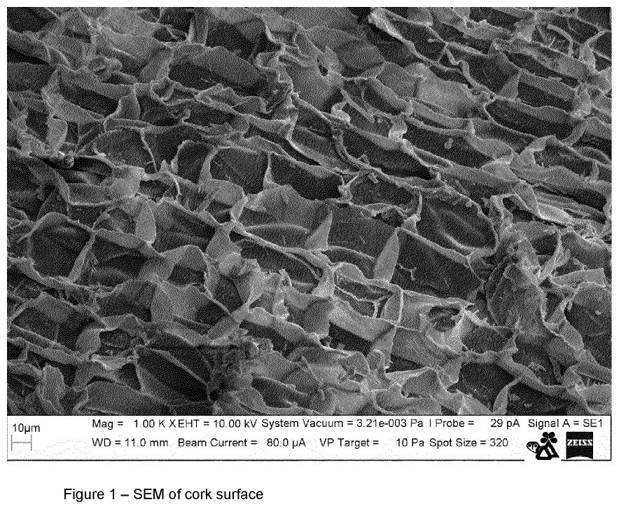

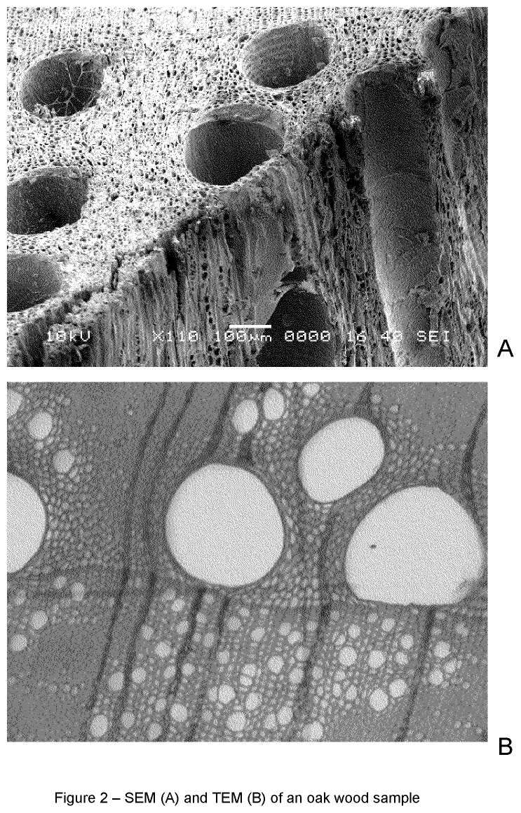

It can be seen by reference to FIG. 1 herein that cork is an example of a natural material which has a “closed cell” structure. Cork has very low porosity (in the pore size range above 1 μm, such as 1 μm to 200 μm), as can also be seen from FIG. 1. Many other natural materials, including those which are typically thought of as impermeable, such as wood, in fact have an “open” surface, having a considerable density of pores above 1 μm. This is true even in relatively dense wood, as is illustrated in FIG. 2, which shows micrographs of an oak wood sample. Cork thus forms a highly suitable filler material in all aspects and embodiments of the present invention.

Cork which is porous and does not fall under the definition of “non-porous” as described herein is not suitable as the non-porous filler material. The filler preferably does not comprise porous cork. The filler preferably comprises cork of a commercial grade one or two. Porous cork is not a common type of cork nor is the term “cork” typically used to indicate any porous material. The term “cork” as used herein thus takes its natural definition, which does not encompass porous materials.

In one embodiment, the filler material comprises at least 10% suberin (e.g. 10 to 50% suberin).

Another material which has very low porosity (except at the cut ends of fibres) is coir (coconut fibre). This fibre, especially in lengths of 1 mm or greater (e.g. 1 mm to 30 cm such as 2 mm to 50 mm or 5 mm to 20 mm) may form a further suitable filler material for all compatible aspects and embodiments of the invention.

In a preferable embodiment the filler material comprises closed cell coir. Reference is made to an SEM image of coir from the paper Tran et al (Industrial Crops and Products 65 (2015) 437-445—see FIG. 2) (incorporated herein by reference). This Figure demonstrates the closed cell nature of coir. As one can see from this image, the coir comprises multiple small pockets between each elementary fibres of the coir (i.e. lumen as described therein) which are confined to the internal section of the coir. Thus, “pores” are present only on the cut ends of the coir and such pores are not open to the structure of the fibre but only extend to the depth of a singe closed cell within the material. Coir is thus also a closed-cell material as described herein.

In one embodiment, the particulate filler material will comprise, consist essentially of or consist of a material comprising cellulose (including hemicellulose) and/or lignin. In particular, the filler material may be a material comprising at least 10% by weight cellulose (including hemicellulose) and at least 10% by weight lignin.

In another embodiment, the particulate filler material will be free (or substantially free) of absorbent (porous) material. It is preferred if the particulate filler materials comprise less than 10 wt % of porous polysaccharide materials. Porous polysaccharide materials include wood chips/dust, maize fibres and starches (e.g. starch fibres).

It is preferred that the filler is not a human food substance. In one embodiment, the filler material preferably does not contain significant food value as a human food. In one embodiment, the filler material does not contain more than 20% (e.g. contains 0 to 20% or 0.0001 to 20%) by weight starch. In one embodiment, the filler is not an edible flour. In particular, the filler is not a flour or other particulate derived from grain or quinoa and thus is not, for example, wheat flour, rice flour quinoa or related products. This has two advantages: Such food material tends to be porous and so does not readily form the stable, low-binder material which can be formed from cork, coir and similar closed-cell materials. Also, it is preferable not to use human food grade materials for non-food use.

In a certain embodiment, the filler is free or substantially free of polysaccharide food additives, such as xanthan gum and/or cellulose gum.

In one favoured embodiment applicable to all aspects of the invention, the filler material will comprise, consist essentially of or consist of bark, a bark product or bark layer. In a preferred embodiment, the filler will comprise, consist essentially of or consist of all or a part of the peridermal layer of a bark. In one embodiment, the filler may comprise, consist essentially of or consist of rhytidome.

In one embodiment, the natural filler material (e.g. cork or coconut fibre) will have a density of around 30 to 500 g/L. This will preferably be around 50 to 250 g/L, 80 to 220 g/L or 60 to 180 g/L. Common cork densities of around 100-175 g/L are highly appropriate.

Common densities of (unground) coconut fibres around 100-200 g/L are highly appropriate.

In a further preferred embodiment, the filler may comprise, consist essentially of or consist of cork.

In an especially preferred embodiment, the filler will comprise, consist essentially of or consist of non-porous, closed-cell cork (as defined herein in any suitable embodiment).

In another preferred embodiment, the filler will comprise, consist essentially of or consist of non-porous, closed-cell coir (as defined herein in any suitable embodiment).

In another preferred embodiment, the filler will comprise, consist essentially of or consist of a mixture of non-porous, closed-cell coir and non-porous, closed-cell cork (both as defined herein in any suitable embodiment).

Bark is present only on woody plants-herbaceous plants and stems of young plants lack bark. It is preferred that bark referred to herein is bark from the mature stems of woody plants, and thus typically comprises periderm (cork, cork cambium, phelloderm), cortex and phloem. The periderm, and especially the cork layers are particularly preferred in the present disclosure, although all layers of bark may be used as appropriate.

Cork is an impermeable, buoyant material formed of the phellem layer of bark tissue in woody plants. Cork cell walls contain suberin, a waxy substance which protects the stem against water loss, the invasion of insects into the stem, and prevents infections by bacteria and fungal spores. The cells within cork entrap gas, similar to air, which provides the cork with a low density, elasticity and with insulating and fire-retardant properties. Because of its impermeable, buoyant, elastic, and fire retardant properties, cork is used in a variety of products. Cork is present in the bark of most woody plants but is typically harvested from certain varieties of tree, particularly the cork oak (Quercus suber) or Chinese cork oak (Quercus variabilis).

Cork, as referred to herein may be any form of cork but will preferably be cork harvested from the cork oak (Quercus suber) or Chinese cork oak (Quercus variabilis). Typically, cork comprises suberin (~40%), lignin (~22%), cellulose and hemicellulose (~18%), wax and other materials.

In one embodiment, the filler material may comprise at least 10% by weight suberin (e.g. 10 to 60%), such as 15 to 50% or 30 to 45% by weight suberin.

The filler material utilised in the various aspects and embodiments of the invention is a particulate material.

Typical sizes for the particulate material will correspond to “sand”-type sizes. These may be of average particle size 50 μm to 5 mm (e.g. 63 μm to 5 mm), preferably 95 μm to 3 mm. Particle sizes, may also encompass gravel and small pebble-size fillers of average particle sizes up to around 10 mm. When referring to an individual particle, sizes are generally the smallest diameter (i.e. the diameter in the smallest axis). Fillers may be “monomodal”, “bimodal” or “polymodal” in that one, or more than one size of filler particle may be present. For example, a fine filler with average particle size less than 100 μm may be used in combination with a more course filler of particle size 1 mm or larger (e.g. 1 to 10 mm or 1 mm to 5 mm). Such a bimodal mixture of fillers allows for better coating of the larger particles and may improve the properties of the binder. Typically, in such cases, the filler(s) of larger particle size(s) will be the closed-cell filler. Evidently, all filler materials of all particle sizes may be formed from one or more closed-cell fillers. Where a bimodal filler is used, in one embodiment a first particle size maximum may be present at a particle size at least twice as large as the second particle size maximum (e.g. 2-100 times as large). In such cases and where the two sizes of particle have similar density (e.g. +50%), in one embodiment, the filler component may comprise at least 60% by weight of the larger size filler, preferably at least 75% by weight. For such distributions, whatever the relative densities of the fillers, in one embodiment, the filler component may comprise at least 60% (e.g. 75%) of the larger filler particles by volume.

In one embodiment, the moulding compositions may comprise a “large” filler comprising at least one closed-cell particulate filler as described herein and a “small” filler, which may be a closed-cell particulate filler or another filler type. The “large” filler particle size may be an average of 300 μm to 10 mm, such as 500 μm to 5 mm. The “small” filler particle size may be an average of 0.1 μm to 100 μm, such as 0.5 μm to 50 μm or 1 to 30 μm. The small and large filler particles may be the same or different filler materials.

In one embodiment, at least 20 wt % (e.g. 20 to 100 wt %), such as at least 30 wt or at least 50 wt % (e.g. 50 to 100%) of the filler components in the mouldable composition will be closed-cell filler(s). This will preferably be at least 60% or at least 75%, such as at least 80%, at least 90% or at least 95%. In one embodiment substantially 100% of the filler material will be closed-cell filler.

In a further embodiment, at least 30 vol % of the filler components in the mouldable composition will be closed-cell filler(s). This will preferably be at least 40% or at least 60%, such as at least 70%, at least 80% or at least 90% by volume. In one embodiment substantially 100% of the filler material will be closed-cell filler.

In an especially preferred embodiment, the filler will comprise more “large” filler than “small” filler. The ratio of “large” filler to “small” filler is preferably in the range of 55:45 to 90:10 by weight or by volume. It is especially preferred to have a ratio of the “large” filler to “small” filler in the range of 60:40 and 75:25 by weight and/or 75:25 to 90:10 by volume.

In a specific embodiment, the filler will comprise natural non-porous filler material and at least one additional filler material, wherein the additional filler may comprise an inorganic filler and/or polymer filler. In a specific embodiment, the filler will comprise natural non-porous filler material and at least one additional filler material in a ratio of 55:45 to 90:10 by weight or by volume. It is especially preferred to have a ratio of the non-porous filler material and the additional filler material in a range of 60:40 to 75:25 by weight and/or 75:25 to 90:10 by volume.

Additional filler material may be any suitable inert material but will typically be a particulate material such as at least one inorganic filler and/or at least one polymer filler. Suitable materials include sand, glass (e.g. borosilicate glass), silica, calcium carbonate and other “inorganic” materials such as minerals; and polymers including natural, semi-synthetic and synthetic polymers. Natural polymers may include polyphenol and polysaccharide based fillers including lignin and cellulose type fillers such as wood dust, as well as carbohydrate type fillers such as wheat flour, rice flour or corn flour. Synthetic polymers include polyolefins (e.g. polystyrene, polyethylene or polypropylene), polyesters (e.g. polyethylene terephthalate (PET), polybutyrate), polyamide, polyurethane etc. as well as mixtures thereof. Expanded materials including hollow glass microspheres and expanded polymers (polymer foams) such as foam latex, polyurethane forms, expanded PVC, expanded polystyrene or expanded polyethylene and copolymers comprising any of these. One particularly suitable expanded material is “Expancel”, a copolymer of vinylidene chloride, acrylonitrile and methyl methacrylate, typically formulated with isobutene as a blowing agent.

In an alternative embodiment, the “large” filler is free or substantially free of inorganic or mineral filler (e.g. natural or industrial minerals (such as kaolin, silica and/or perlite)). In a preferred embodiment the non-porous filler material is free or substantially free of inorganic natural or industrial minerals (such as kaolin, silica and/or perlite). In a specific embodiment, the filler is free or substantially free of inorganic industrial minerals (such as kaolin, silica and/or perlite, especially kaolin).

A highly suitable “small” filler is finely powdered calcium carbonate or silica. Such a filler does not have a significant effect on the texture of the binder or mouldable material but serves to increase the bulk of the binder components. Finely powdered fillers (“small fillers”) of this type may have an average particle size of below 20 μm (e.g. 0.5 to 20 μm), preferably below 10 μm (e.g. 1 to 10 μm). An average particle size of 0.5 to 8 or 2 to 20 μm is highly suitable for such small fillers, which may be formed of any filler material disclosed herein, particularly inorganic fillers such as silica or calcium carbonate. Such small filler particles may form the only filler (where formed from a closed-cell filler material) but will more typically be used in combination with a larger (closed-cell) filler material.

Silica fillers, particularly hydrophobised silica fillers, form a highly preferred mineral filler for use as a “small filler”, forming a part of the filler component of the present invention in combination with a close-cell filler. Such small particle silica fillers may be added in an amount of around 1 to 30% by weight of all components in the composition. When this pre-filled composition is then added to a larger quantity (especially larger volume) of another filler (see below for typical filler quantities) the small filler has the effect of increasing the volume and potentially also the binding effect of the binder without requiring more binder (e.g. polymer, or other components such as softeners).

In one advantageous embodiment, the various products of the present invention may include both a “small filler” such as hydrophobised fumed silica filler or a small particle calcium carbonate filler and a closed-cell filler of any of the types indicated herein. This provides advantages to the elasticity and robustness of the binder, especially when the small filler (e.g. hydrophobised fumed silica filler) is employed at a level of around 5 to 30 wt % (e.g. 10 to 25% or 5 to 15%) relative to the total of that filler and the binder components. Preferred hydrophobised fumed silica fillers may comprise various particle sizes including aggregates of small particles. Typical aggregated fumed silica particles may be in the range 1 to 100 μm, preferably around 5 to 50 μm in smallest dimension.

All fillers, especially mineral fillers including glass, sand, silica, alumina and other mineral fillers, may be surface-treated. Many useful surface treatments exist to improve various properties such as performance and/or appearance. One preferred surface treatment is hydrophobic surface treatment to “hydrophobise” the surface of the filler. Surface-treated (e.g. hydrophobised) glass, sand, silica and/or alumina thus form preferred fillers in the present invention. Suitable surface treatment, particularly for silica-containing fillers, may include treatment with alkoxy silanes or silyl alkanoates at 0.05 to 0.2% by weight of the filler.

The mouldable materials of the present invention comprise at least one filler (including a natural, closed-cell filler) and at least one binder material. The proportion of binder material to filler material may vary significantly depending upon the use to which the mouldable material is to be put. For example, the ratio of binder to total filler may be in the range 1:99 to 99:1 by weight to 1:99 to 99:1 by volume. This will vary depending upon the nature of the binder, the nature of the filler(s) and the purpose of the material. For example, binder: filler ratios of 2:98 to 98:2 or 5:95 to 95:5 may be appropriate, as may ratios of 90:10 to 10:90 or 75:25 to 25:75, either by weight or by volume. Where the filler consists of a natural closed-cell filler (generally at 50-100% by total volume of the filler) and optionally another low-density filler such as hollow glass or polymer microspheres or blown polymer foams, the binder will generally be the larger component by mass and the binder: filler ratios may be 50:50 to 98:2, such as 60:40 to 95:5 or 70:30 to 90:10 by weight.

Where the filler component contains a natural closed-cell filler (generally at 50-99% by total volume of the filler) and an additional filler such as an inorganic (e.g. silica) or polymer filler then the total density of the filler will be higher than above. In such cases the binder: filler ratios may be 90:10 to 10:90, such as 60:40 to 40:60 or 70:30 to 30:70 by weight.

In a preferred embodiment there will be a larger quantity by weight of filler than binder in the composition. In an especially preferred embodiment, the ratio of filler to binder will be in the range of 51:49 to 90:10 by weight such as 51:49 to 75:25. In a preferred embodiment there will be a larger quantity by volume of filler than binder in the composition. In an especially preferred embodiment, the ratio of filler to binder will be in the range of 51:49 to 95:5 by volume, such as 60:40 to 92:8. It is especially preferred that the ratio of filler/binder by volume is in the range of 70:30 to 95:5, such as 80:20 and 90:10.

One potentially valuable use of the materials of the present invention are in fire retardants. Natural fillers such as cork are highly insulating and naturally fire retardant and may be used as such in the materials of the present invention. The fire retardant properties of the material may be further enhanced by the addition of a secondary filler material, particularly an inorganic/mineral filler. In one embodiment, the present invention therefore provides a fire retardant material as described in any embodiment or aspect herein wherein that material contains at least one particulate, natural, closed-cell filler and optionally at least one mineral filler. Suitable closed-cell fillers include cork. Suitable mineral fillers include any of those discussed herein including silica (e.g. sand) and/or calcium carbonate.

In the mouldable compositions and all aspects and embodiments of the present invention, a binder material is required.

Suitable binders for use in all aspects and embodiments of the invention include silicone-based binders, poly ester binders, poly amide binders and substituted aliphatic polymer binders. Particular examples include polyesters such as poly caprolactones (optionally copolymerised with lactate monomers) and substituted aliphatic polymers such as polyvinyl acetate (homo-polymers or copolymers). Silicone binders include polyalkylsiloxane binders, optionally crosslinked with materials such as alkyl silyl alkanoates.

In a preferred embodiment, the binder component comprises less than 10 wt %, such as less than 5 wt % of polysaccharides (e.g. cellulose, starch). In a further preferred embodiment (combinable with the previous), the binder component comprises less than 10 wt %, such as less than 5 wt % of polyethers (e.g. polyethylene glycol). In a preferred embodiment the binder is free or substantially free from polysaccharides and polyethers.

In one embodiment, the mouldable materials of the invention do not contain (or substantially do not contain) cellulose in solution. For example, the materials of the present invention may contain less than 5% by weight (e.g. 0 to 5%) cellulose in solution.

In one embodiment, the silicone binder may be formed of polyalkylsiloxanes such as polydimethyl siloxane (e.g. hydroxy-terminated PDMS). Any suitable siloxane or mixture thereof may be used, such as those with MW between 1 kD and 50 kD, such as between 2 kD and 30 kD. Mixtures of at least one low MW (e.g. 1 to 10 kD) siloxane and one higher MW (e.g. 12 to 30 kD) siloxane form a suitable embodiment.

Crosslinking of the siloxane binder may be partially covalent, such as with silyl alkanoates (e.g. triacetoxy silane) or alkoxy silanes (e.g. trimethoxy silane or Triethoxy (2,4,4-trimethylpentyl) silane). Alternatively, or in addition, crosslinking may be by means of a boron compound (e.g. a boron compound such as boric acid or sodium borate, or a boron-containing ceramic or glass, such as borosilicate glass). In on embodiment, both boron crosslinking and covalent crosslinking may be used.

It has been found that mouldable compositions formed from closed-cell natural particulate fillers may be effectively coated with binder using less binder than would be required for other natural filler materials. Furthermore, the close-cell or non-porous nature of the filler particles is believed to limit the absorption of the binder and thus reduce the “drying” of the material by migration of the binder away from the particle surface over time.

Binders typically include additional optional components such as softeners and/or anti-tack agents. The amount of softener and/or anti-tack agent in the binder component a) will depend upon the nature of the polymer. Where present, the amount of softener will typically be less than 80% by weight of component a) with the remainder of that component being polymer. This may be 1 to 50% softener or 5 to 35% by weight.

Binders may be constantly flexible or may be “set” by means of drying, heating or setting (e.g. with UV light). Similarly, binders may be flexible at room temperature or may require heating to become flexible. In one embodiment, the binder may be rigid at 20° C. but flexible at 42° C.

Some preferred examples of binders for component a) include:
i) 30 to 70% Polyvinyl acetate homopolymer, Polyvinyl acetate copolymer (e.g. with at least one other vinyl ester) or a mixture thereof, with 30 to 70% of at least one hydroxylated or esterified softener (such as at least one glycerol ester and/or C10-C22 branched or straight-chain alkyl alcohol (e.g. mono-ol, diol or triol));
ii) 20 to 80% of at least one polyester homopolymer or copolymer (e.g. at least one homopolymer or copolymer of caprolactone) and 20 to 80% of at least one softener (e.g. MW 50 to 500 amu). Suitable softeners may comprise at least one benzyl alcohol, benzyl ester, benzyl ether and/or benzoic acyl moiety; or
iii) at least one covalently cross-linked siloxanyl polymer, optionally further crosslinked with up to 5% (. 0 or 0.01% to 5%), especially up to 0.5% (e.g. 0 or 0.01 to 0.5%, such as 0.1 to 0.3% or 0.15 to 0.25%) by weight boron.
iv) at least one non covalently cross-linked siloxanyl polymer (i.e. a polymer not having covalent crosslinks), crosslinked with up to 5% (e.g. 0 or 0.01 to 5%, such as 0.01 to 0.5 or 2% or 0.1 to 1.0%) by weight boron.

Binder ii) may be rigid at 20° C. but flexible at 42° C.

In all embodiments i) to iv) above all % are by weight based on the binder material

In all embodiments utilising boron crosslinking, the amount of boron refers to that boron which is available for crosslinking. This will be the total amount present for a simple compound like boric acid but will be the accessible amount for boron which is present as a part of the matrix of a glass or ceramic material (as in the examples). In borosilicate glass spheres, for example, the boron in the centre of the particle will be less available and the amount of “available” boron will be around 4000 to 8000 ppm (weight). Around 5000 ppm is a typical amount. In all aspects of the present invention, the products and compositions may comprise at least one of various optional components such as;
c) a pigment;
d) a glitter;
e) a mica or coated mica;
f) a perfume;
g) a preservative; and/or
h) a fire-retardant.

Each optional component provides advantages which are useful and valuable in certain embodiments and certain applications and may be selected independently and used individually or in any combination where technically feasible. The various components are described herein separately for clarity but may be used in combination to provide desirable properties to the compositions of the invention.

Examples of each of these additives are well known to the skilled worker. Glitter, as referred to herein includes plastic film based glitter (e.g. polystyrene film glitter) or plastic-free glitter (e.g. TiO₂, fluorphlogopite, tin dioxide, or mixtures thereof).

Additional components c) to h) or other additional components, where present, will each typically be present at no more than 5% by weight (e.g. 0.01 to 5%) of the total composition. This will preferably be no more than 2% or no more than 1% by weight.

In one embodiment, the present disclosure provides for a method for manufacture of any of the mouldable materials of the present invention. A suitable method may comprise, for example, forming a suitable binder component a) (e.g. as described herein) and heating or dissolving the binder and thereafter mixing the binder or binder solution with a particulate filler component b) whereby to at least partially coat the particles of filler with the binder. The material may then be dried to remove solvent as necessary.

The mouldable material should be mouldable at a low temperature. In a preferable embodiment, the mouldable material is mouldable between room temperature and 50° C., such as in the range of 18 to 45° C., such as 21 to 42° C. or 25 to 37° C. Herein “mouldable” is defined as malleable without excessive manual force (e.g. through manipulating the material in the user's hands).

As used herein, the term “about”, “around” “substantially” or “approximately” in relation to a number or a range of numbers will generally indicate that the number or range specified is preferred but that such a number may be varied to a certain extend without materially affecting the properties of the relevant material, composition, method or product. The skilled worker will typically be able to readily establish the extent by which such numbers may be varied without prejudicing the key advantages of the present invention. As a general guide, such numbers or the ends of such ranges referred to with such terms may be varied by +20% or +10%, preferably +5% and more preferably +1%. A corresponding meaning may be attributed to compositions “consisting essentially of” certain components, which may include up to 20% or up to 10%, preferably up to 5% and most preferably up to 1% of other components in addition to those specified. Compositions described as comprising or consisting essentially of certain components include a disclosure of the compositions consisting solely of those components. All percentages herein are given by weight unless otherwise specified or unless context requires another meaning. Similarly, a material which is “substantially free” of another substance will typically contain no more than 20% (i.e. 0 to 20%) of that substance, preferably no more than 10%, no more than 5%, no more than 2% or no more than 1% of the specified substance. This may be by weight or by volume as appropriate but most commonly will be by weight unless context indicates otherwise.

Where the density of a particulate material is referred to herein, it is the bulk density which is intended, where context allows. Density is typically of the “as used” material rather than of material crushed or ground to a powder prior to measurement.

### EXAMPLES

TABLE 1
Raw materials used in the examples.

| Commercial name | Chemical name/description | Abbreviation |
|---|---|---|
| Ingevity CAPA6500 | Polycaprolactone homopolymer, Mw ca | CAPA6500 |
| | 50 kD | |
| Eastman Benzoflex | Dipropyleneglycol dibenzoate and | Benzoflex988 |
| 988 | benzoate esters | |
| Wacker AK10 | Polydimethylsiloxane (PDMS), Mw ca. | AK10 |
| | 1100 | |
| Wacker Vinnapas B | Vinyllaurate-vinylacetate copolymer with | B500/40VL |
| 500/40 VL | 40% vinyllaurate, Mw ca. 200 kD | |
| 3M Glass Bubbles | Hollow glass sphere D50 size of 80 | K37 |
| K37 | micrometer | |
| Eastman Triacetin | Triacetin | Triacetin |
| Sasol Isofol 20 | 2-Octyl-1-dodecanol | Isofol20 |
| Danisco MCT60 | Glyceryl Tricaprylate-caprate | MCT60 |
| Westfield | Natural cork granules, 0.2 mm to 0.5 mm in | Cork (0.2-0.5) |
| Technologies Cork | diameter, density 150 kg/m3 | |
| granules | | |
| Westfield | Natural cork granules, 0.5 mm to 1.0 mm in | Cork (0.5-1.0) |
| Technologies Cork | diameter, density 150 kg/m3 | |
| granules | | |
| Westfield | Natural cork granules, 2 mm to 3 mm in | Cork (2-3) |
| Technologies Cork | diameter, density 150 kg/m3 | |
| granules | | |
| Westfield | Natural cork granules, 2 mm to 3 mm in | Cork (2-3) LD |
| Technologies Cork | diameter, density 70 kg/m3 | |
| granules | | |
| Local carpenter, No | Birch saw dust, up to 0.5 mm in diameter, | Sawdust (0.5) |
| name | density 260 kg/m3 | |
| Local carpenter, No | Wood chips from alder trees, 2 mm to | Woodchips (2- |
| name | 5 mm in diameter, density 230 kg/m3 | 5) |
| Rettenmaier & | Ground naked corn cobs, 0.1 mm to | Corncobs |
| Söhne, Rehofix | 0.3 mm in diameter, density 470 kg/m3 | (0.1-0.3) |
| Rettenmaier & | Ground naked corn cobs, 0.2 mm to 1 mm | Corncobs |
| Söhne, Rehofix | in diameter, density 450 kg/m3 | (0.2-1) |
| Rettenmaier & | Ground naked corn cobs, 1 mm to 5 mm in | Corncobs (1- |
| Söhne, Mais chipsi | diameter, density 400 kg/m3 | 5) |
| Sibelco Nordic, | Silica sand Mam1s, D50 0.2 mm, density | Sand (0.2) |
| sand Mam1s | 1600 kg/m3 | |
| Agro Biothers, | Coconut fibres | Coconut fibres |
| Coconut Nest, | | |
| 100% coconut | | |
| fibres | | |
| Wacker CDS100 | hydroxyl-terminated polydimethyl siloxane | CDS100 |
| | (PDMS) Mw ca 4 kD | |
| Wacker C2T | hydroxyl-terminated PDMS Mw ca 20 kD | C2T |
| Wacker Crosslinker | Triacetoxy ethylsilane | ES23 |
| ES23 | | |
| Oleon Radiacid | Partially hydrogenated tallow fatty acids | Radiacid0406 |
| 0406 | | |
| DuPont Danisco | Acetic Acid Ester | SnS |
| Grindsted Soft-n- | | |
| Safe | | |
| Univar Hydrochloric | 9% wt hydrochloric acid in aqueous | HCl(9%) |
| acid | solution | |
| Wacker, Geniosil | trimethoxyvinylsilane | XL10 |
| XL10 | | |
| Wacker, BS1701 | Triethoxy(2,4,4-trimethylpentyl)silane | BS1701 |
| Local supermarket, | 24% acetic acid in aqueous solution | HAc(24%) |
| Acetic acid (24%) | | |

### Example 1—PVAc-Binder

(i) 52.6 g B500/40VL was melted and mixed with 36.5 g Isofol20, 4.6 g MCT60, and 6.4 g Triacetin.
(ii) 42.6 g of the binder (i) was mixed with 57.4 g Cork (0.5-1.0) to obtain a cohesive moldable material. The texture is soft and pliable and the material flows and has an ‘alive’ appearance.
(iii) 57.1 g of the binder (i) was mixed with 42.9 g Cork (0.2-0.5) to obtain a cohesive moldable material. The texture is soft and pliable and the material flows and has an ‘alive’ appearance.
(iv) 52.6 g B500/40VL was melted and mixed with 36.5 g Isofol20, 8.3 g MCT60, and 6.4 g Triacetin to obtain a somewhat modified, softer binder (as compared to binder (i)). This binder was mixed 76.3 g with 23.7 g Cork (0.2-0.5) to obtain a cohesive moldable material. This material flows less than (ii) and (iii) and therefore has a less ‘alive’ appearance. The texture is doughy because of a higher volume ratio of binder, yet easy to mold due to the softer texture, and shaped construction structures can be formed.

### Example 2—PCL-binder

36 g CAPA6500 was melted and mixed with 64 g Benzoflex988 to obtain binder (v).

This binder (v) was mixed (vi) 35 g to 15 g Cork (0.5-1.0), or (vii) 35 g to 15 g Cork (0.2-0.5). Both materials (vi and vii) could be molded at ca. 40C when the binder is in a molten phase. When structures have been formed they were let resting, and when they had cooled to room temperature they solidified to rigid structures. The heating and molding could be repeated, and new solid structures formed.

Both materials (vi and vii) were somewhat sticky to hands in the molten phase (above 40° C.). This could be opposed by adding AK10, ca. 1% by weight, to the materials.

### Example 3—Silicone Binder

Preparation (viii) was prepared by cross-linking 397 g C2T with 3.5 g ES23. The reaction took place during mixing the two components at a temperature of about 130° C. The crosslinking gave a strongly increased viscosity. Then 530 g CDS100 was added to the reaction vessel and mixed in. The reaction was assumed completed after three hours.

Preparations (ix), (x), and (xi) were obtained by mixing appropriate amounts of the first 4 components (table 2) at a temperature of about 60° C. Then Radiacid0406 was added, melted, and mixed in properly. HCl(9%) was added to the mixture and water was evaporated. Finally, and when present in the recipe SnS was added. After proper mixing the texture of the final materials (ix), (x), and (xi) are doughy yet with an ‘alive’ feeling. The materials can be used to build structures when compressed, yet they have a fluffy appearance and flows when played lightly with (without excessive compression forces).

TABLE 2
Amounts of raw materials in the examples with silicone-based binder.

| Raw materials | (ix)/gram | (ix)/% | (x)/gram | (x)/% | (xi)/gram | (xi)/% |
|---|---|---|---|---|---|---|
| Cork (0.2-0.5) | 45.0 | 36.1 | 23.0 | 34.0 | — | — |
| Cork (0.5-1.0) | — | — | — | — | 100 | 48.5 |
| K37 | 19.0 | 15.2 | 13.5 | 20.0 | 40 | 19.4 |
| Preparation | 57.0 | 45.7 | 28.6 | 42.3 | 55 | 26.7 |
| (viii) | | | | | | |
| Isofol20 | 1.8 | 1.44 | 1.5 | 2.2 | 3.0 | 1.5 |
| Radiacid0406 | 1.1 | 0.88 | 0.55 | 0.81 | 8.0 | 3.9 |
| SnS | 0.73 | 0.59 | 0.41 | 0.61 | — | — |
| HCl(9%) | 11.5 | — | 7.4 | — | 15 | — |

### Example 4—Cork Compared with Other Natural Filler Materials

In the mixtures xii to xx binder of type (i) (see Example 1) was used and properties of materials prepared with various organic fillers were compared. For comparison purposes, mixture xxi was prepared with inert sand filler. The mixtures were compensated for the different filler densities such that the similar volume fractions (binder to filler) were compared, Table 3.

The ratio (by volume) which was used was approximately 88:12 filler to binder.

Before mixing with the binder Sand (0.2) was surface treated to improve compatibility with binder (i). First an aqueous silane dispersion was prepared:
5 g silane was weighed out (0.5 g BS1701 and 4.5 g XL10) and mixed in a beaker with a magnetic stirrer.
The silane (mixture) was added to an aqueous solution of 94.5 g water and 0.5 g HAc (24%) under vigorous stirring to provide a course dispersion
Mixing (vigorous) continued for ca. 30-60 min before contact with heated sand (below)

Then surface treated sand. Sand (0.2) ST was prepared:
5 kg sand was heated to some 55-60 C in a stainless-steel pot
The aqueous silane dispersion (100 g—approx. 5% silane in water) was added to the hot sand under continuous mixing.
Mixing continued until water had evaporated and the sand was dry

TABLE 3
Density compensated preparations. Just after preparation (0 h) all samples
were cohesive.

| | | | | | | | |
|---|---|---|---|---|---|---|---|
| | | weight | | | | | |
| | | ratio | | | | | |
| | | binder/ | Observation | Observation | Observation | Observation | Observations after |
| No | Filler | filler | after 15 h | after 60 h | after 240 h | after 480 h | 1 year |

Inventive Examples

| | | | | | | | |
|---|---|---|---|---|---|---|---|
| (xii) | Cork(0.2-0.5) | 45/55 | Virtually no | Virtually no | Virtually no | Virtually no | Still cohesive but |
| | | | change | change | change | change | initially a |
| | | | | | | | shorter/dryer |
| | | | | | | | feeling. Much of the |
| | | | | | | | original cohesive |
| | | | | | | | texture/stretch can |
| | | | | | | | be recovered by |
| | | | | | | | kneading the |
| | | | | | | | material for a few |
| | | | | | | | minutes. |
| (xiii) | Cork(0.5-1.0) | 45/55 | Virtually no | Virtually no | Virtually no | Virtually no | Same as for (xii). |
| | | | change | change | change | change | |
| (xiv) | Cork(2-3) | 45/55 | Virtually no | Virtually no | Virtually no | Virtually no | Same as for (xii). |
| | | | change | change | change | change | |
| (xv) | Cork(2-3)LD | 63/37 | Virtually no | Virtually no | Virtually no | Virtually no | Same as for (xii). |
| | | | change | change | change | change | |

Comparative Examples

| | | | | | | | |
|---|---|---|---|---|---|---|---|
| (xvi) | Sawdust(0.5) | 32/68 | Crumbly, | Continued | Continued | Continued | Crumbly, sub- |
| | | | suboptimal | drying, | drying, | drying, | optimal cohesion |
| | | | cohesion | crumbly, | crumbly, | crumbly, | but similar in |
| | | | | suboptimal | suboptimal | suboptimal | texture as 480 h |
| | | | | cohesion | cohesion | cohesion | observation. |
| (xvii) | Woodchips | 34/66 | Somewhat | Continued | Too dry, | Too dry | Has a ‘wet’ look but |
| | (2-5) | | dryer and | drying and | almost no | almost no | no cohesion. |
| | | | less | less | cohesion | cohesion | |
| | | | cohesive | cohesiveness | | | |
| (xviii) | Corncobs | 20/80 | Crumbly, | Crumbly, filler | Too dry, | Too dry, | Dry and no |
| | (0.1-0.3) | | suboptimal | particles | almost no | almost no | cohesion. |
| | | | cohesion | drizzle out | cohesion | cohesion | |
| | | | | from formula | | | |
| (xix) | Corncobs | 21/79 | Somewhat | Crumbly, short | Too dry, | Too dry, | Dry and no |
| | (0.2-1) | | dryer and | in texture, filler | almost no | almost no | cohesion. |
| | | | less | particles | cohesion | cohesion | |
| | | | cohesive | drizzle out | | | |
| | | | | from formula | | | |
| (xx) | Corncobs | 23/77 | Somewhat | Yet less | Yet less | Yet less | Has a ‘wet’ look but |
| | (1-5) | | dryer and | cohesive, and | cohesive, | cohesive, | no cohesion. |
| | | | less | on the verge | and on the | and on the | |
| | | | cohesive | to fall apart | verge to fall | verge to fall | |
| | | | | | apart | apart | |
| (xxi) | Sand(0.2)ST | 7/93 | No change | No change | No change | No change | No change. |

Just after preparation all materials were doughy and well working mouldable materials, suitable for modelling and children's play. The saw dust preparation had a somewhat harder, less mouldable texture than the others. Samples filled with cork were soft and had a particularly pleasant touch and feel, while the samples prepared with ground naked corn cobs and with woodchips had an ‘edgy’, less soft and less smooth feeling.

Already after 15 h there were noticeable changes to several of the preparations. Inert sand filler and cork-based fillers appeared to be less affected by aging, compared to preparations with saw dust, wood chips, and ground naked corn cobs. Over time a continuous change of material properties was observed for all samples, except for these prepared with inert sand-filler or with cork-filler.

Sample (xix) was investigated further, and in particular the gradual change over time resulted in a material being too ‘dry’ and non-cohesive to be useful after a storage time of 480 h. The ‘dry’ sample had a ‘wet’ look but obviously the binder was not accessible on the surfaces of the filler particles. New additional binder was added to the ‘dry’ sample in small proportions. Properties were judged and compared to a freshly prepared reference sample. After six consecutive additions corresponding to adding an extra ca. 70% binder the initial properties were recovered. This shows that a substantial amount of the initially added binder volume had been absorbed by the filler particles and was inaccessible.

### Example 5—Alternative Natural Non-Porous Fillers

Related to cork also coconut fibres appear to have a non-porous surface structure. Fibres were cut by hand with a pair of scissors and sieved to obtain a size sorted fraction were most of the fibres had a length 1 mm to 5 mm-coconut fibres (1-5). The density of coconut fibres (1-5) was estimated by weighing a tapped volume. After adjustment to the similar volume ratio (binder to filler) as in preparations xii to xxi, a sample xxii was prepared (40 wt % binder (i) and 60 wt % coconut fibres (1-5)).

The density of coir is known to be in the range 1.1-1.5 g/mL when measured on the ground powder. Herein, density is calculated on coconut fibres which have not been ground. The density is calculated to be less than 0.2 g/mL.

Material xxii had doughy properties and a soft and ‘hairy’ appearance. Due to the length of the fibres there was a resistance to mold and shape. One way to oppose this is by using shorter fibres, or alternatively by blending the coconut fibres with a granular filler (e.g. an inorganic or polymer filler or a natural filler such as cork).

Material xxiii was prepared by mixing equal volumes of samples xiii and xxii. The 1:1-mixture, xxiii, kept a significant proportion of the ‘hairy’ appearance from xxii while adopting much of its mold-and-shape properties from xiii.

Just like with cork the coconut-fibres filled samples conserve the properties over the investigated storage time and no change was observed after 15 h, 60h, 240 h or 480h.

When revisiting the sample after 1 year, it still had a texture such that could be worked with and shaped. After working with the material for a few minutes (i.e. kneading) the texture returned to closely resemble the initial texture.

### Example 6—Alternative Silicone Binder

The method of Example 3 was repeated with an alternative silicone-based binder. This binder is crosslinked with boron only (in the form of borosilicate glass spheres) and does not contain significant covalent crosslinking.

The (xxiv)-material, see table below, was prepared with cork (0.2-0.5) and gave cohesive and useful properties, while it was ‘shorter’ in texture than material (x). (x) and (xxiv) are closely similar in composition but the balance of physical and covalent crosslinks differs. (x) has more covalent crosslinks in the network than (xxiv) has.

TABLE 4
Amounts of raw materials in the examples with
an alternative silicone-based binder (xxiv).

| Raw materials | /gram | /% |
|---|---|---|
| Cork (0.2-0.5) | 23 | 34.3 |
| K37 | 15 | 22.4 |
| C2T | 12 | 17.9 |
| CDS100 | 16 | 23.9 |
| Isofol20 | 0.4 | 0.6 |
| Radiacid0406 | 0.6 | 0.8 |
| SnS | 0.1 | 0.15 |
| HCl(9%) | 8.2 | — |

Finally a sample (xxv) was prepared based on ground corncobs. The formula was compensated for the different filler density as compared to sample:

| Raw materials | /gram | /% |
|---|---|---|
| Corncobs(0.2-1) | 69 | 61.0 |
| K37 | 15* | 13.3 |
| C2T | 12 | 10.6 |
| CDS100 | 16 | 14.2 |
| Isofol20 | 0.4 | 0.3 |
| Radiacid0406 | 0.6 | 0.5 |
| SnS | 0.1 | 0.1 |
| HCl(9%) | 8.2 | — |

Sample (xxv) based on corncobs (0.2-1) was too dry and had undesirable properties, which is in contrast to the corresponding sample (xxiv) based on cork (0.2-0.5).

1. A mouldable material comprising;
a) at least one binder; and
b) at least one particulate filler material;
wherein the filler material comprises a natural, non-porous filler material.

2. The mouldable material of claim 1 wherein filler component b) consists of at least one natural non-porous filler material.

3. The mouldable material of claim 1 wherein filler component b) comprises at least one natural non-porous filler material and at least one additional filler material selected from inorganic fillers and polymer fillers.

4. The mouldable material of claim 3 wherein the ratio of the natural non-porous filler material to the at least one additional filler material is 55:45 to 90:10 by weight or by volume.

5. The mouldable material of claim 1 wherein the natural non-porous filler material is free of any industrial or natural mineral.

6. The mouldable material of claim 1 wherein the non-porous filler material comprises a closed-cell filler material.

7. The mouldable material of claim 1 wherein the filler material has less than 10% of the surface area formed of surface pores larger than 2 μm in diameter which are deeper than 100 μm.

8. The mouldable material of claim 1 wherein the non-porous filler material comprises at least one compressible natural material.

9. The mouldable material of claim 1 wherein the closed-cell filler material comprises at least 10% suberin.

10. The mouldable material of claim 1 wherein the filler material comprises a bark or bark derivative.

11. The mouldable material of claim 1 wherein the non-porous filler material comprises cork.

12. The mouldable material of claim 1 wherein the non-porous filler material comprises coconut fibre.

13. The mouldable material of claim 1 wherein the non-porous filler material comprises a mixture of cork and coconut fibre.

14. The mouldable material of claim 1 wherein the binder is selected from a silicone-based binder, a poly ester binder, a poly amide binder, a substituted aliphatic polymer binder and mixtures thereof.

15. The mouldable material of claim 1 wherein the binder is selected from
i) 30 to 70% polyvinyl acetate homopolymer, polyvinyl acetate copolymer or a mixture thereof, with 30 to 70% of at least one hydroxylated or esterified softener;
ii) 20 to 80% of at least one polyester homopolymer or copolymer of caprolactone and 20 to 80% of at least one softener;
iii) at least one covalently cross-linked siloxanyl polymer, optionally further crosslinked with up to 5 wt % boron; or
iv) at least one non covalently cross-linked siloxanyl polymer, crosslinked with up to 5 wt % boron.

16. The mouldable material of claim 1 wherein component a) is substantially free of polysaccharides and/or polyethers.

17. The mouldable material of claim 1 wherein component a) is present at 2 to 98% of the composition by weight.

18. The mouldable material of claim 1 wherein component b) is present at 2 to 98% of the composition by weight.

19. The mouldable material of claim 1 wherein there is more component b) than component a) by weight and/or by volume.

20. The mouldable material of claim 1 wherein the ratio of b) to a) is in the range of 51:49 to 95:5 by volume.

21. The mouldable material of claim 1 wherein the composition comprises at least one component selected from:
c) a pigment;
d) a glitter;
e) a mica or coated mica;
f) a perfume;
g) a preservative;
h) a fire-retardant;
and mixtures thereof.

22. The mouldable material of claim 1 which is mouldable at at least one temperature between 18 and 50° C.

23. A product selected from a modelling compound, an artistic material, a child's play material, a filler material, a construction material, a packaging material, an insulating material and/or a fire-retardant material prepared from the mouldable composition of claim 1.

24. A method of using a mouldable composition as claimed in claim 1 as a modelling compound, an artistic material, a child's play material, a filler material, a construction material, a packaging material, an insulating material and/or a fire-retardant material.

25. A method for forming a mouldable material as claimed in, claim 1, said method comprising combining the binder a) with the particulate filler material b) wherein the filler material comprises a natural, non-porous filler material.
